(19) United States
(12) Patent Application Publication
(10) Pub. No.: US 2007/0098407 A1
(43) Pub. Date: May 3, 2007

(54) Methods and Apparatus for Communication Using UV Light

(75) Inventors: Jack Hebrank, Durham, NC (US); Charles Eric Hunter, Jefferson, NC (US); Michael A. Weiner, New York, NY (US); Robert F. Davis, Raleigh, NC (US); Laurie E. McNeil, Chapel Hill, NC (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Next Safety, Inc., Jefferson, NC (US)

(21) Appl. No.: 11/533,667

(22) Filed: Sep. 20, 2006

Related U.S. Application Data
(63) Continuation of application No. 11/283,182, filed on Nov. 19, 2005, now abandoned.
Application No. 11/283,182 is a continuation of application No. 10/521,186, now abandoned.
(60) Provisional application No. 60/396,753, filed on Jul. 19, 2002.

(51) Int. Cl. H04B 10/00

(52) U.S. Cl. 398/106

(57) ABSTRACT

Communication methods and apparatus using ultraviolet (UV) light are provided. Save UV communication devices, including remote control units, can use highly efficient UV LEDs and very low-noise UV photodetectors. In some cases, the LEDs emit light at wavelengths below 400 nm, below 320 nm, or even below 280 nm. In one embodiment, communication can be achieved using an LED that emits less than about 1 picowatt of UV energy at a photodetector distance of up to at least about 10 meters. Longer range communication can also be achieved at higher power levels. Photodetectors having very low dark currents at room temperature, such as below about 1×10⁻⁹ A/m², are preferable.

### CROSS-REFERENCE TO RELATED APPLICATION

This application is a continuation of application Ser. No. 11/283,182, filed Nov. 19, 2005, which is a continuation of application Ser. No. 10/521,186, filed Jul. 17, 2003, which is a national phase filing of PCT/US03/22471, filed Jul. 17, 2003, which claimed the benefit of Provisional Application No. 60/396,753, filed Jul. 19, 2002, each of these applications are incorporated herein by reference.

Short-range (e.g., less than about 10 meters) communication links are currently used by many consumer electronic devices, including desktop, notebook, and palm computers, televisions, remote control units, printers, digital cameras, public phones, and kiosks, cellular phones, pagers, personal digital assistants, electronic books, electronic wallets, toys, watches, and other mobile devices. These links currently use infrared (hereinafter, “IR”) light generated by light emitting diodes (hereinafter, “LEDs”) or radio frequency (hereinafter, “RF”) wireless links. RF wireless links are especially useful when non-directional communication links are desired.

Medium-range (e.g., less than about 100 meters) and long-range (e.g., greater than about 100 meters) wireless communication links are sometimes also employed by these consumer devices as well. Industrial applications include land, air, and sea-based stationary and mobile communication networks, which may include extended-range remote control units.

The use of IR LEDs is a result of the early development of high power LEDs generating energy at a wavelength of 880 nanometers, and the relative absence of light sources at that wavelength in home, office, and manufacturing environments. The Infrared Data Association®(hereinafter, “IrDA”) Physical Layer Specification sets a standard for IR transceivers, modulation or encoding/decoding methods, as well as other physical parameters. According to the standard, an IrDA communication system uses IR light with a peak wavelength of 850 to 900 nanometers. The transmitter's minimum and maximum intensity is 40 and 500 mW/Sr within a 30 degree cone. The Receiver's minimum and maximum sensitivity is 0.0040 and 500 mW/(cm²) within a similar 30 degree cone. There are a number of IrDA modulation or encoding/decoding methods, some of which have been developed to reduce power consumption.

Ultraviolet (hereinafter, “UV”) light communication systems are known but they are not generally used for short-range communication links, at least partially because UV radiation can be dangerous to humans. Nonetheless, the market for short-range wireless communication links, including just IR and RF systems, is very large. For example, in the year 2000, stand-alone sales of universal remote control units in the U.S. were estimated to be about 35 million units. Moreover, global sales of remote control units in year 2000 are believed to have been about $1.6 billion.

Short-range wireless links are also used in many security systems, which has an annual US market of about $19.5 billion. Moreover, the market for wireless identification/information devices is large and exemplified by SpeedPass, a technology introduced in 1996 that had approximately five million subscribers by November, 2001.

Traffic detection and speed monitoring devices, including intrusive and non-intrusive devices, form another large market for wireless communication devices. Intrusive sensors have been attached directly to or beneath a road surface, and include inductive loops, pneumatic road tubes, and piezoelectric cables. Non-intrusive sensors use video image processing and microwave radar and infrared detection schemes. Although non-intrusive sensors are more convenient, they are generally expensive to manufacture and normally consume substantial amounts of power.

When IR or RF methods are used to establish even short-range communication links, significant operational power levels (often on the order of milliwatts) are required to overcome environmental noise levels, usually requiring that they be connected to significant power sources. Also, IR data transmission rates are often bandwidth limited by the presence of electronic filters to reduce sensor noise. Conventional wireless links are also susceptible to interference and interception by other units.

It would therefore be desirable to provide reliable, compact, and inexpensive methods and apparatus for safe, low-power, UV light-based communication.

It would also be desirable to provide methods and apparatus for short-range, medium-range, and long-range UV light-based communication.

It would also be desirable to provide methods and apparatus for material detection.

It would also be desirable to provide methods and apparatus for security systems.

It would also be desirable to provide methods and apparatus for identification and informational tagging.

Consistent with this invention, a low-power wireless remote control unit is provided for use with a low-noise UV photodetector. The remote control unit includes a UV LED that emits light having a dominant wavelength below about 400 nm, a control device connected to the UV LED for controlling (e.g., modulating) the emitted light, and an energy storage device for storing electrical energy and powering the UV LED, control device, and any other associated electronics. Preferably, the control devices includes an electronic control device, such as a microprocessor. A microprocessor can be, for example, an ASIC, and can include any amplifiers, filters, or desired circuitry.

In some embodiments, the LED emits—at light having a wavelength below about 380 nm or even below about 290 nm, but preferably above about 260. To operate at the low power levels, the communication bandwidth should be near the LED dominant wavelength, and near the peak responsivity of the photodetector (e.g., which may include one or more integrated amplifiers).

Also, safe UV communication is possible with this invention by operating the LED such that it emits less than about 1 milliwatt, less than about 1 microwatt, or less than about one picowatt of UV light energy during communication with the photodetector at a distance of up to about 10 meters. Alternatively, safe UV communication is possible by operating the LED such that it emits less than about 1 microwatt, or less than about one nanowatt, of UV light energy during communication with the photodetector at a distance of up to about 1 meter. It will be appreciated that longer (shorter) range communication can be achieved at higher (lower) LED power levels.

The photodetector preferably has a dark current at room temperature of less than about 1×10⁻⁹ A/m², but is preferably less than about 1×10⁻¹² A/m², or and most preferably less than about 1×10⁻¹⁵ A/m².

A material detector capable of detecting any UV absorptive or reflective material is also provided. The material detector includes at least one LED that emits UV light, at least one UV photodetector that detects the light and generates at least one electrical signal that is indicative of the amount of the light being detected, and a microprocessor (e.g., such as an ASIC) and any associated electronics (including one or more amplifiers), coupled to the photodetector, for receiving the electrical signal. The microprocessor is programmed to analyze the signal to determine whether any material is present between the diode and the photodetector, and to generate an alarm signal when the material is determined to be present. Methods are also provided to distinguish between different types of material.

### BRIEF DESCRIPTION OF DRAWINGS

The above and other objects and advantages of the invention will be apparent upon consideration of the following detailed description, taken in conjunction with the accompanying drawings, in which like reference characters refer to like parts throughout, and in which:

FIG. 1 shows a simplified schematic diagram of an illustrative one-way communication system consistent with this invention;

FIG. 2 shows a simplified schematic diagram of a two-way communication system consistent with this invention;

FIG. 3 shows an illustrative remote control unit with a UV LED, a microprocessor (and any gating or modulating circuitry), and an energy storage device consistent with this invention;

FIG. 3A shows another illustrative remote control unit with a UV LED, a microprocessor (and any gating or modulating circuitry), an energy storage device, and a transducer, such as photovoltaic cell, consistent with this invention;

FIG. 4 shows an elevational view of a residential home with three networked devices consistent with this invention;

FIG. 5 shows a simplified schematic diagram of an illustrative repeater consistent with this invention;

FIG. 6 shows a simplified security system that includes three illustrative LED/photodetector pairs consistent with this invention;

FIG. 7 shows another simplified security system that includes one illustrative LED/photodetector pair and multiple mirrors consistent with this invention;

FIG. 8 shows an illustrative system for making measuring the speed of vehicles consistent with this invention;

FIG. 9 shows an illustrative receiver unit consistent with this invention for use as a shopping checkout device;

FIG. 10 shows a simplified schematic diagram of an illustrative transceiver that includes a UV LED, a UV photodetector, an energy storage device, and a microprocessor consistent with this invention;

FIG. 11 shows the transceiver of FIG. 10 as part of a window security system consistent with this invention;

FIG. 12 shows a simplified transmitter that includes a directional UV light source using a micro-mirror-device consistent with this invention;

FIG. 13 shows a micro-electro-mechanical photodetector 600 with multiple photodetector portions consistent with this invention;

FIG. 14 shows a concave array of micro-electro-mechanical photodetectors, each of which is connected to a power source and a microprocessor for controlling the position of each photodetector portion and processing the electrical signal generated by the many photodetector portions consistent with this invention;

FIG. 15 shows another array of micro-electro-mechanical photodetectors similar to array shown in FIG. 14, except that the array has a convex shape consistent with this invention; and

FIG. 16 shows two aircraft equipped with UV transceivers consistent with this invention.

Methods and apparatus consistent with this invention use UV light to form one-way and two-way wireless communication links. Some of the communication devices consistent with this invention include low-power remote control units, residential and commercial security systems, devices for monitoring and controlling manufacturing processes, vehicular detection and traffic speed measuring devices, physical tracking and tagging systems, and communication devices, including devices that can operate covertly and in the solar-blind region.

Furthermore, UV light-based communication systems consistent with this invention are more secure than conventional IR and RF links. Unlike IR and RF, UV is absorbed by painted walls and common window glass, thereby preventing UV from escaping from a room and allowing someone outside the room to eavesdrop. Thus, low operational power levels and high material attenuation from natural environmental barriers enables relatively secure indoor communication with minimal interference.

TABLE 1 shows a number of applications and benefits of this invention:

TABLE 1

| | | | | Solar- |
|---|---|---|---|---|
| | Low-power | Line-of-sight | Physical Tracking | blind |
| Appli- | consumer | security, e.g., | product ID | low power |
| cations | electronics | intruder & fire | assembly tracking | covert |
| | computer | manufacturing | in manufacturer | |
| | peripherals | monitoring | luggage ID | |
| | | vehicle detection | commerce | |
| Benefits | low power | high sensitivity | high sensitivity | difficult to |
| | high | low cost | low cost | jam |
| | sensitivity | small size | | high |
| | can operate | | | bandwidth |
| | without | | | |
| | battery | | | |
| | secure | | | |

### Low-Power UV Communication

A low-power UV light-based communication system consistent with this invention allows remote communications systems, such as those including remote control units (e.g., television remote control units), to be wireless and, in some cases, without a battery. Due to the high sensitivity of commercially available UV photodetectors and the high conversion efficiencies and power outputs of currently available UV LEDs, short-range, medium-range, and even long-range UV communication methods and systems consistent with this invention can operate at decreased power levels with increased reliability and safety. Also, UV LEDs and photodetectors are inexpensive, small, and durable.

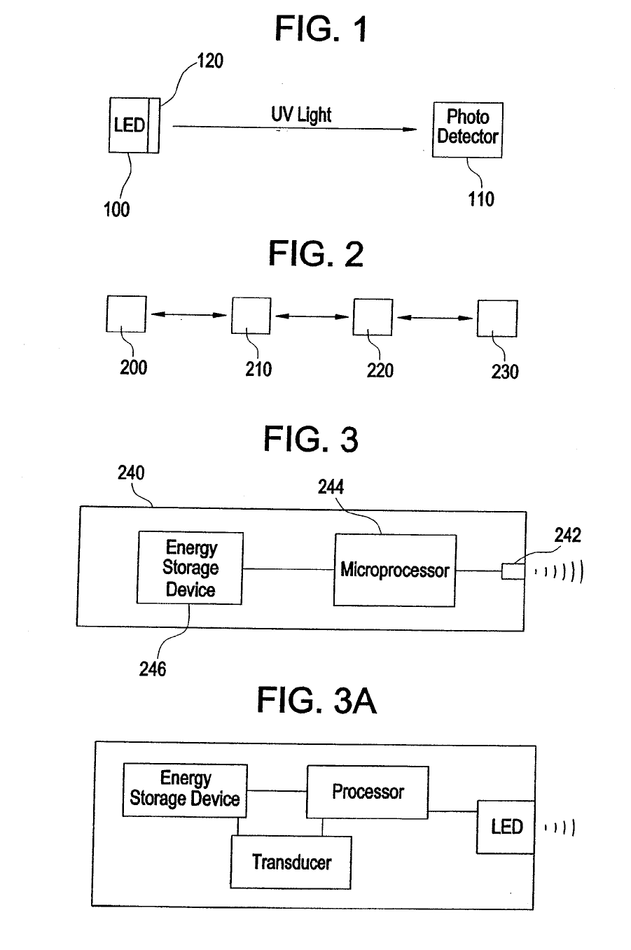

FIG. 1, for example, shows an illustrative one-way communications system that includes UV LED 100 solid-state UV photodetector 110, and optional filter 120 on LED 100 for selecting an appropriate communication wavelength. As discussed more fully below, it will be appreciated that filter 120 can be located anywhere between LED 100 and photodetector 110, including on photodetector 110. FIG. 2 shows a two-way system that includes multiple transceivers 200, 210, 220, and 230, each of which at least includes a UV LED and a low-noise photodetector.

To achieve the low power levels consistent with one aspect of this invention, a UV LED can have an efficiency greater than about 10%, 30%, or more preferably greater than about 50% at a dominant wavelength between about 250 nm and about 400 nm. A low-noise UV photodetector preferably has a high quantum efficiency greater than about 30%, about 50%, or even greater than about 70% (for at least one wavelength between about 250 nm and about 360 nm). Alternatively, a low-noise UV photodetector can have a quantum efficiency greater than about 10% or greater than about 30% (for at least one wavelength between about 330 nm and about 400 nm)

The electromagnetic spectrum includes wavelengths in what is known as the “solar-blind region,” that is wavelengths less than about 290 nm. When the UV communication wavelength is within the solar-blind region, the background noise level is very low, which reduces the power required to operate the LED and photodetector. As shown in TABLE 2 (see below), a UV LED with a 15 degree beam angle operating with only 10 picowatts of electrical energy allows reliable communication over a distance of at least up to about 10 meters. This low-power requirement compares favorably to the tens of milliwatts currently needed to power IR LEDs in conventional remote control units used, for example, with televisions. The low power levels consistent with this invention enable a range of nearly powerless, light-weight, wireless applications that are extraordinarily safe.

Operation of a low-power UV communication system consistent with this invention can be modeled by considering a UV LED and a UV photodetector separated by a distance d (m). To proceed, the following nomenclature (and their units) are defined: I_{D} (A/m²) is the dark current density of the photodetector, S is the signal-to-noise ratio of the photodetector, Q (electrons/photon) is the quantum efficiency of the photodetector, A_{D} (m²) is the active area of the photodetector, γ(nm) is the UV light wavelength, r (m) is the radius of illuminated area, α(deg) is the emitter viewing angle.

Using this nomenclature, a desired photodetector current density (A/m²) Iₐ is given by:
Iₐ=SI_{D}.

The units of this photodetector current density can be converted from (A/m²) to (electrons/m²-sec) as follows:

$${I}_{e} = \frac{{I}_{α}}{( 1.6 \times {10}^{- 19} C \text{/} electron )} .$$

This density can be further converted to the desired photon flux N (photons/m²-sec) at the photodetector according to the following relationship:
N=Iₑ/Q

From this number it is possible to calculate the desired light intensity IP (photons/m²−sec) at the photodetector:
Iₚ=N/A_{D}

Then, the desired light intensity (W/m²) at the LED I_{w} is given by:

$${I}_{w} = {I}_{p} \frac{1239.8 eV \text{-} nm}{λ} ( 1.6 \times {10}^{- 19} J \text{/} eV ) ,$$

and the area (m²) illuminated by the LED A_{S} at distance d is given by:

$${A}_{S} = π {r}^{2} = {π ( d tan \frac{α}{2} )}^{2} .$$

Therefore, the optical power output P that must be emitted by the LED to produce the desired detector current density (W) is given by:
P=I_{w}A_{S}

Thus, the required optical power output P can be rewritten as:

$$P = \frac{{SI}_{D}}{Q} \frac{1239.8}{λ} {π ( d tan \frac{α}{2} )}^{2} .$$

TABLE 2 summarizes a number of emitter power outputs for two different commercially available photodetectors at different wavelengths, quantum efficiencies, emitter-photodetector distances, and emitter viewing angles, based on the above formula:

TABLE 2

| I_{D} | A_{D} | | | | | α | |
|---|---|---|---|---|---|---|---|
| (A/m²) | (m²) | S | λ | Q | d (m) | (deg) | P (W) |
| 10⁻⁹ | 4 × 10⁻⁶ | 10 | 280 | 0.8 | 1000 | 30 | 31 |
| | | | | | | 15 | 8 |
| | | | | | 100 | 30 | 300 × 10⁻³ |
| | | | | | | 15 | 80 × 10⁻³ |
| | | | | | 10 | 30 | 300 × 10⁻⁶ |
| | | | | | | 15 | 80 × 10⁻⁶ |
| | | | 380 | 0.1 | 1000 | 30 | 183 |
| | | | | | | 15 | 44 |
| | | | | | 100 | 30 | 1.8 |
| | | | | | | 15 | 400 × 10⁻³ |
| | | | | | 10 | 30 | 18 × 10⁻³ |
| | | | | | | 15 | 4 × 10⁻³ |
| 10⁻¹⁸ | | | 280 | 0.8 | 1000 | 30 | 30 × 10⁻⁹ |
| | | | | | | 15 | 8 × 10⁻⁹ |
| | | | | | 100 | 30 | 300 × 10⁻¹² |
| | | | | | | 15 | 80 × 10⁻¹² |
| | | | | | 10 | 30 | 3 × 10⁻¹² |
| | | | | | | 15 | 800 × 10⁻¹⁵ |
| | | | 380 | 0.1 | 1000 | 30 | 183 × 10⁻⁹ |
| | | | | | | 15 | 440 × 10⁻¹² |
| | | | | | 100 | 30 | 1.8 × 10⁻⁹ |
| | | | | | | 15 | 400 × 10⁻¹² |
| | | | | | 10 | 30 | 18 × 10⁻¹² |
| | | | | | | 15 | 4 × 10⁻¹² |

A photodetector having a dark current density of 10⁻⁹ A/m² was described in J. Edmond, H. Kong, A. Suvorov, D. Waltz and C. Carter Jr., “6H-Silicon Carbide Light Emitting Diodes and UV Photodiodes,” phys. stat. sol.(a) 162, 481-491 (1997) and corresponds to a 1997 device operated at 100° C. with a bias of −10 V. A photodetector having a dark current density of 10⁻¹⁸ A/m² is also included in the table. High-sensitivity, low-noise photodetector materials, such as alloys of InGaAIN, InGaN, etc, can also be used consistent with this invention.

For example, an AlGaN photodetector can be used to build a communication system consistent with this invention. This type of photodetector is characterized by detectivity D*, which is the signal-to-noise ratio at a particular electrical frequency in a 1 kHz bandwidth when 1 Watt of radiant power is incident on a 1 cm² active area detector (cm-Hz ^{1/2}/W):

$${D}^{*} = \frac{\sqrt{{A}_{D} Δ f}}{NEP} ,$$

where Δf=bandwidth (Hz) and NEP is the noise equivalent power. NEP is the light level incident on a detector that produces an electrical signal equal to the base noise level (W/\sqrt{Hz}). In this case, the desired light intensity I_{W} is given by:

$${I}_{W} = \frac{S \sqrt{\frac{Δ f}{{A}_{D}}}}{{D}^{*}}$$

TABLE 3 summarizes a number of optical power output levels that may be required, at different emitter-detector distances and emitter angles, using a photodetector like the one described by J. D. Brown, Jihong Li, P. Srinivasan, J. Matthews and J. F. Schetzina, “Solar-Blind AlGaN Heterostructure Photodiodes,” MRS Internet Journal Nitride Semiconductor Research 5, 9 (2000). The detectivity value used in TABLE 3 was measured at room temperature at a wavelength corresponding to the peak responsivity of the photodetector. The measured device had an active area of about 200×200 micrometer.

TABLE 3

| D* (cm- | | | λ | Δf | | α | |
|---|---|---|---|---|---|---|---|
| Hz^{1/2}/W) | A_{D} (m²) | S | (nm) | (Hz) | d (nm) | (deg) | P (W) |
| 3.3 × 10¹² | 4 × 10⁻⁶ | 10 | 273 | 1 | 1000 | 30 | 3.4 × 10⁻⁶ |
| | | | | | | 15 | 820 × 10⁻⁹ |
| | | | | | 100 | 30 | 34 × 10⁻⁹ |
| | | | | | | 15 | 8.2 × 10⁻⁹ |
| | | | | | 10 | 30 | 340 × 10⁻¹² |
| | | | | | | 15 | 82 × 10⁻¹² |

Thus, a low-power UV remote control unit consistent with this invention can be used with a low-noise receiver that includes a low-noise UV photodetector. The remote control unit includes a UV LED that emits at least a portion of light having a wavelength below about 400 nm, a microprocessor connected to the LED for controlling the emitted light, and an energy storage device for storing electrical energy and for powering the LED and the microprocessor. FIG. 3 shows illustrative remote control unit 240, with UV LED 242, microprocessor 244, and energy storage device 246. FIG. 3A shows a similar device with a transducer (see below). The transducer supplies electrical energy either directly to an energy storage device or indirectly via circuitry to obtain a desired stored voltage.

A remote control unit consistent with this invention can include an LED that generates less than about 1 milliwatt of UV light in a predetermined bandwidth during communication with the photodetector at a distance of up to about 10 meters. Much smaller UV powers, however, can also be used, such as power levels less than about 1 microwatt, 1 nanoWatt, or even less than about 1 picoWatt depending, inter alia, on the UV wavelength, the desired signal-to-noise ratio, and the environmental noise level.

For example, UV light emission from an LED can have a wavelength below about 350 nm, 320 nm, or even below about 290 nm. If the wavelength is less than about 290 nm (a wavelength within the solar-blind region), an even lower operational power level can be used because of the absence of solar-based noise normally present during daylight hours. Moreover, LEDs that have dominant wavelengths that are greater than the solar-blind cutoff wavelength, but have sufficient spectral emission in the solar-blind region, can also be used to form a communication link in that region with this invention. Suitable LEDs are made, for example, by Cree, Inc., of Durham, N.C.

Communication can also be established over longer distances, if desired, for remote control and other communication applications, such as narrow and high bandwidth data communication systems, including communication systems that convey multimedia data. For example, a communication link can be formed using a UV LED that generates less than about 1 milliWatt of UV light energy during communication with a photodetector at a distance of up to about 100 meters. Again, depending on a number of factors, the LED can also be operated at even lower levels, such as below about 1 microWatt or even below about 1 nanoWatt, using an appropriate photodetector and under proper environmental conditions. It will be appreciated that these distances and LED energy levels can be extrapolated to 1000 meters or more.

When low-power levels are desired, such as in the case where the maximum communication distance is less than about 10 meters and a low-noise UV photodetector is used, the remote control unit can include a transducer that converts non-electrical energy into electrical energy. It will be appreciated that additional voltage control circuitry, which may be part of the microprocessor, can be incorporated into such a device to facilitate charging and/or discharging of the energy storage device.

Because the energy requirements can be so small, the transducer can operate as a primary (or secondary) power source to operate the LED and the microprocessor. If the transducer operates as the primary power source, then the remote control unit does not require a conventional battery. In this case, a simple capacitor will do.

A transducer that can be used consistent with this invention can be, for example, a piezoelectric crystal, a microphone, or a photoelectric cell. The transducer can also be a pendulum-type mechanical-electrical transducer, like the ones used in self-winding watches. Thus, energy can be converted from sound waves and light waves, as well as thermal and pressure gradients. In the case of the pendulum-type transducer, the energy is gravitational potential energy.

As mentioned above, a low-power remote control unit can operate without a battery and requires only a simple capacitor for temporary storage of electrical charge. Generally, the capacitor includes at least two conductive (e.g., metallic) elements separated and insulated from each other by a dielectric material. Such a simple capacitance device can have an extraordinarily low capacitances and still supply a sufficient amount of power to operate the remote control unit for extended periods of time.

For example, if the UV LED is about 30% efficient, and the required optical power level is about 1 microwatt (See, e.g., TABLE 2), then the UV LED would only consume about 3 microWatts of electrical power, assuming continuous emission. If the microprocessor used to modulate the light also consumed about 1 microWatt, the LED would consume about 1 microwatt (although this number can be greater depending on its operational requirements), then 1 hour of continuous operation would only require about 1.4 milliJoules of energy. The energy stored in a capacitor is equal to ½ CV², where C is capacitance and V is the voltage across the capacitor. Thus, if the LED and microprocessor required an operating voltage of about 5 volts, then the remote control unit can be equipped with a capacitor having a capacitance of less than about 800 microfarads. It will be appreciated that because this capacitance calculation conservatively depends on a 30% LED efficiency, one hours of continuous operation, and a relatively high bias voltage, the capacitor can have an actual capacitance that is orders of magnitude smaller than 800 microfarads.

Low-capacitance energy storage devices, such as capacitors that store electric field potential energy, can be distinguished from the more conventional relatively high capacitance energy storage devices, such as wet-cell batteries, that store chemical potential energy. Typical conventional batteries include, for example, sealed Lead acid batteries, Nickel-Cadmium batteries, Nickel-Metal Hydride batteries, Lithium ion batteries, Zinc-air batteries, flooded Lead acid batteries, Alkaline batteries, and any combination thereof.

It will be appreciated that while such conventional chemical-type batteries need not be included in the low-power remote control units consistent with this invention, they may be included to achieve ultra-long operational lifetimes (e.g., on the order of decades). Such ultra-long lifetimes would normally outlast the product being controlled, thereby eliminating the need to ever replace the battery.

Low-power communication links can be used between, for example, computers, wireless keyboards, computer mice, printers, personal digital assistants, and other computer peripheral devices. In one embodiment, a two-way communication system can include two or more transceivers, each having a UV light source, a UV photodetector, and at least one microprocessor to control the light source and the photodetector. The light source preferably emits at least some light having a wavelength below about 400 nm. Thus, the UV photodetector detects light having a wavelength below about 400 nm and generates an electrical signal responsive to the detected light. The photodetector preferably has a dark current at room temperature of less than about 1×10⁻⁹ Amps/m², although photodetectors with substantially lower dark currents are commercially available.

A single microprocessor can be used for controlling the light source and interpreting the electrical signal generated by the photodetector. Alternatively, the communication system can include two or more microprocessors, which may be remote from either the source, the photodetector, or both.

It will also be appreciated that multiple light sources and photodetectors can be used in a system consistent with this invention. For example, the low cost of photodetectors encourages the use of multi-detector applications, such as direction sensing, or even small detector/emitter pairs fabricated as repeaters. In home applications, such repeaters might be used to establish a UV communication network between different rooms.

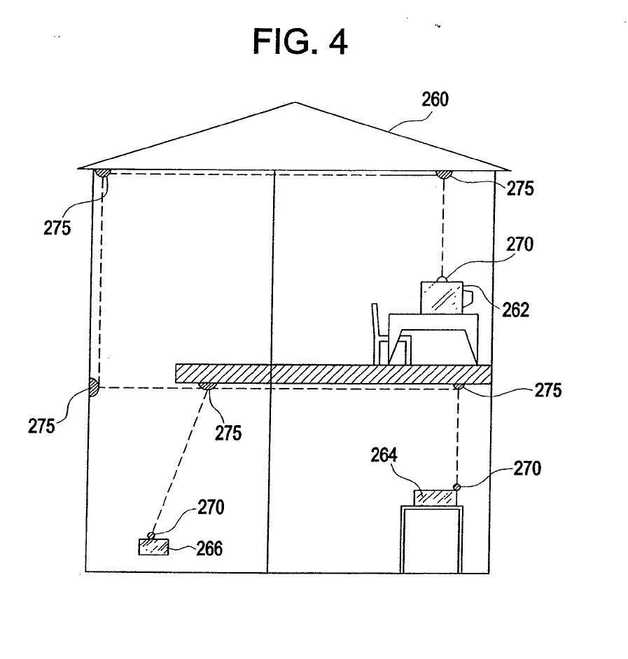

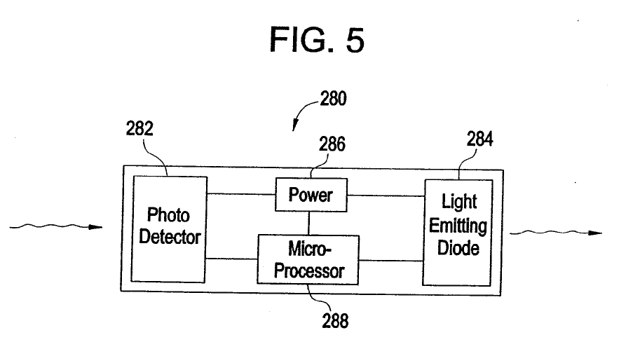

For example, FIG. 4 shows an elevational view of residential home 260 with three networked devices: computer 262, printer 264, and mobile device 266, although additional devices can be networked as well. Each of the devices includes a UV terminal device 270, which can include a UV transmitter, a UV receiver, or both. Terminal devices 270 are in communication with one or more linking devices 275, which may include a mirror, or a repeater. FIG. 5 shows a simplified schematic diagram of illustrative repeater 280. Repeater 280 can include UV photodetector 282, UV LED 284, power source 286, and microprocessor 288 for processing signals generated by photodetector 282 and controlling LED 284.

UV light-based communication systems consistent with this invention have a number of advantages over conventional infrared-based systems. First, infrared emitters require significantly more power than the ultra-low-power requirements of the UV LEDs, which means that batteries can be replaced with very low-cost capacitors and, optionally, transducers. Also, UV systems can have the physical dimensions of a pin head. For example, a detector/emitter pair can be a few millimeters. Also, UV communication systems consistent with this invention can be made more sensitive and reliable than traditional infrared-based remote control units because of the extraordinary sensitivity of advanced UV photodetectors and the lack of background.

Although UV light is generally considered harmful to humans and should be avoided, UV communication systems consistent with this invention are safe because they can operate at extremely low UV light intensities. UV light extends from shorter wavelengths and higher energies (hereinafter, “UVC”) to the longer wavelengths and lower energies (hereinafter, “UVA”). The UVC wavelength range is between about 200 and 280 nanometers, the UVB wavelength range is between about 280 and 320 nanometers, and the UVA range is between about 320 and 400 nanometers.

UVC rays are the most energetic of UV rays and are considered most harmful to humans. Unlike UVA and UVB light, most UVC light is filtered out by the earth's ozone layer and falls within what is commonly referred to as the “solar-blind” region. The 1996 allowed limit for UVR radiation (i.e., the total UV radiation limit, including UVA, UVB, and UVC) is 1 mW/m². Typical values for doses delivered by fluorescent lamps (mercury-vapor) such as are found in homes or offices, without plastic diffusers, are 80-120 microW/m², or about 10% of the limits without diffusers. See, Whillock et al., “UV radiation levels associated with the use of fluorescent general lighting, UV-A and UV-B lamps in the workplace and home,” Chilton. NFRPB-R221 (1988). In comparison, doses delivered by UV communication devices consistent with this invention can be orders or magnitude less than that of conventional fluorescent general lighting. In some short-range embodiments, doses can be on the order of picoW/m² or even less. Thus, the ultra-low-power characteristics of UV emitter/detector pairs consistent with this invention allow emitters to operate at power levels that are so low that they pose essentially no threat to human or animal safety.

### Line-of-Sight Applications

The low-power characteristics of this invention enable the design of “line-of-sight” applications because they can operate without harm to humans and other animals. The basic concept uses an emitter to send a beam of UV light to a photodetector. In one embodiment, when a line-of-sight communication link is interrupted, the interruption indicates an occurrence of an event that can be detected and reported. Alternatively, an event can be detected when a clear line-of-sight between an emitter and a photodetector is established, such as when an object is removed from that line-of-sight.

For example, indoor security and smoke detection devices can be built consistent with this invention. Line-of-sight detection using UV LEDs and photodetectors can be used to build residential and commercial systems that combine indoor security with fire and smoke detection. A receiver unit, for example, can include a UV photodetector and any type of transmitter, such as IR, UV, and RF transmitters. A UV security system can detect the presence of any material that is capable of at least partially blocking a UV beam and can report its presence to another system, such as an alarm system. Depending on the beam intensity, systems could be calibrated to detect a number of different blocking events, including the presence of intruders or smoke. For example, the presence of smoke between the emitter/photodetector pair would cause the amount of UV light received at the photodetector to decrease in a way that is different from the presence of an intruder. Advantageously, security systems consistent with this invention can be integrated with other security devices, such as CO detectors and IR temperature sensors, to monitor trends and relationships to ensure that the interrupting event (e.g., a fire) has been properly identified.

Indoor security and smoke detection devices that use UV light provide numerous benefits over conventional devices. With respect to the security systems, the UV techniques consistent with this invention are safe because the UV intensities can be made extremely low. Also, the systems can be made wireless and small, making them more aesthetically pleasing and less detectable by potential intruders. Moreover, because of recent advancements in the field of semiconductor processing, the emitters and photodetectors can be made very inexpensively. Furthermore, the devices are simple to install and allow for easy beam height and spread adjustments.

Another advantage is that security and smoke detection systems consistent with this invention can be self-calibrating. For example, a smoke detection device can be programmed to monitor the UV characteristics of a room for a period of time. That period of time can span several days to take into account normal daily fluctuations, such as increased smoke levels that result from cooking activities during meal times. In this way, the microprocessor will only generate a smoke alarm signal when it is determined that the smoke level exceeds some time-dependent threshold.

Smoke detection devices that use UV light also provide numerous benefits over conventional ones. Conventional smoke detectors are generally bulky devices that hang from ceilings. The large size of conventional detectors is largely determined by their method of operation; they detect smoke using an ionization process initiated by radioactive materials. In contrast, smoke detectors consistent with this invention are very small, can be easily installed in new or existing buildings without extensive retrofitting, and use no radioactive materials. This allows devices consistent with this invention to be built and used inexpensively and safely disposed.

In addition to smoke, this invention can be used to detect the presence of dust, dirt, and the like. A dust detector according to this invention can be used, for example, to monitor the presence of dust in a semiconductor processing facility that must meet a predetermined clean standard. It will be appreciated, however, that a dust detector consistent with this invention can be used in any environment in which the dust particle density must monitored. It will be further appreciated that the dust particle density on a surface can be measured by reflecting a UV beam of light on the surface and monitoring the intensity of the reflection.

Thus, an LED-based material detector consistent with this invention can include at least one LED that emits UV light, at least one UV photodetector that detects the light and generates at least one electrical signal that is indicative of the amount of the light being detected, and at least one microprocessor. The microprocessor can be coupled to the photodetector for receiving the generated electrical signal and programmed to analyze the signal to determine whether any material is present between any LED/photodetector pair and to generate an alarm signal when such a material is determined to be present.

As shown in FIG. 1, for example, one or more optical filters can be used between an emitter/photodetector pair. The filters can be band-pass filters, low-pass filters, or any other type of convenient optical filter. The filters can be placed on the surface of the LED, on the surface of the photodetector, or both. Multiple filters having different optical characteristics can be used for different LED/photodetector pairs to allow a one photodetector to discriminate between different LEDs. Optical filters are easily fabricated as separate or integrated components for UV emitters and photodetectors. Moreover, the use of filters minimizes living organisms' exposure to wavelengths outside the communication bandwidth.

As mentioned above, a UV detectable material is any material that “blocks” a UV light beam, including materials that reflect and/or absorb UV light. Thus, the material can be a gas, a fluid, a solid, a colloidal solution, smoke, vapor, and any combination thereof. The material, then, can be a living organism, such as a human being or other animal. In this case, the detector can be operated as a security system in which the unauthorized presence of an intruder can be detected and reported in any convenient way, including electronic, telephonic, or audible notifications.

Because each of these UV detectable materials has a somewhat different UV detection property, it is also possible to program the microprocessor to identify the material interrupting the line-of-sight based on these properties. The identification process can use a single LED/photodetector pair, or multiple pairs.

For example, if multiple pairs are used, a microprocessor can analyze the electrical signals generated by the photodetectors by comparing these levels to each other. If the electrical signals are generated by photodetectors located within a single room then, based on a comparison of those signals alone, it is possible to determine the type of the material present. Alternatively signals from multiple locations can be compared to make different types of determinations.

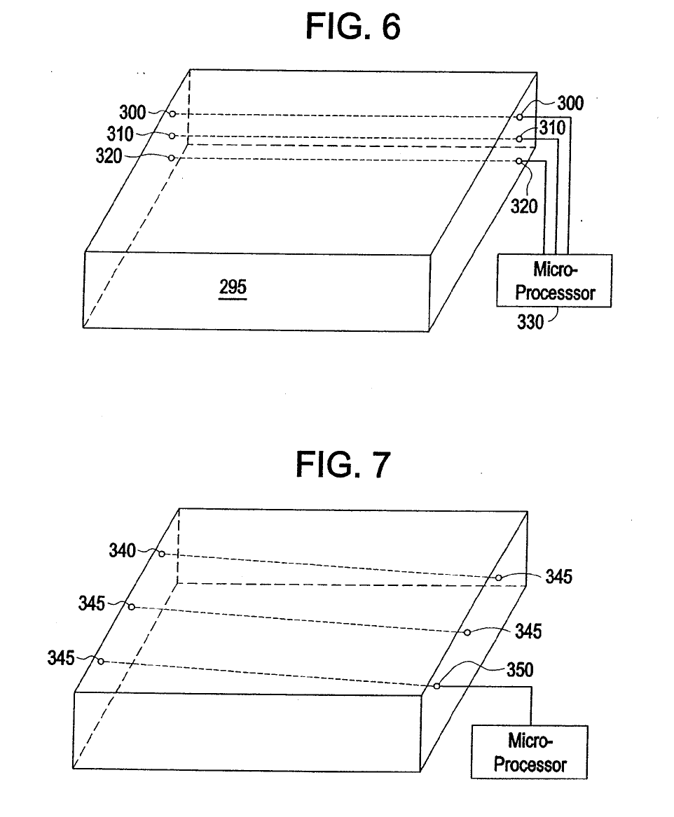

In one embodiment, multiple LED/photodetector pairs can form multiple substantially horizontal lines-of-sight located at different vertical positions in a room. FIG. 6, for example, shows three illustrative pairs 300, 310, and 320 in typical room 295. Each of the photodetectors are coupled (in a wired or wireless fashion) to microprocessor 330, which can be programmed to identify a fire if the pairs are interrupted sequentially (vertically).

In another embodiment, shown in FIG. 7, a UV beam can be emitted from UV LED 340, reflected by one or more mirrors 345, and received by UV photodetector 350 to cover the room using only one LED/photodetector pair. The mirrors can be located along an optical path connecting an LED/photodetector pair, thereby allowing highly circuitous paths and allowing a single pair to secure very long distances, including, for example, the perimeter of a room, a building, or building complex. The use of mirrors also enables very dense coverage by repeatedly folding the optical beam back and forth, such as across a window or door (see, e.g, FIG. 7).

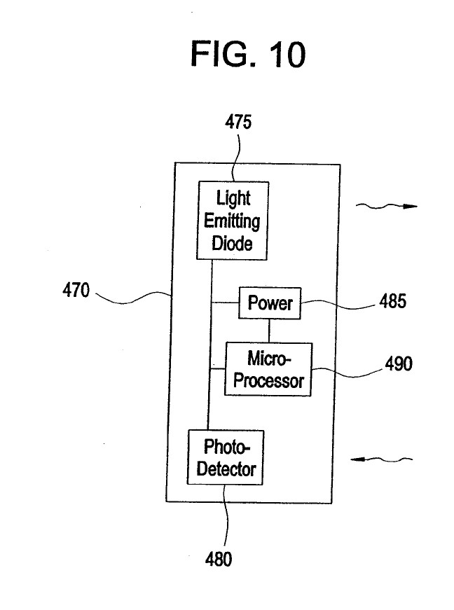

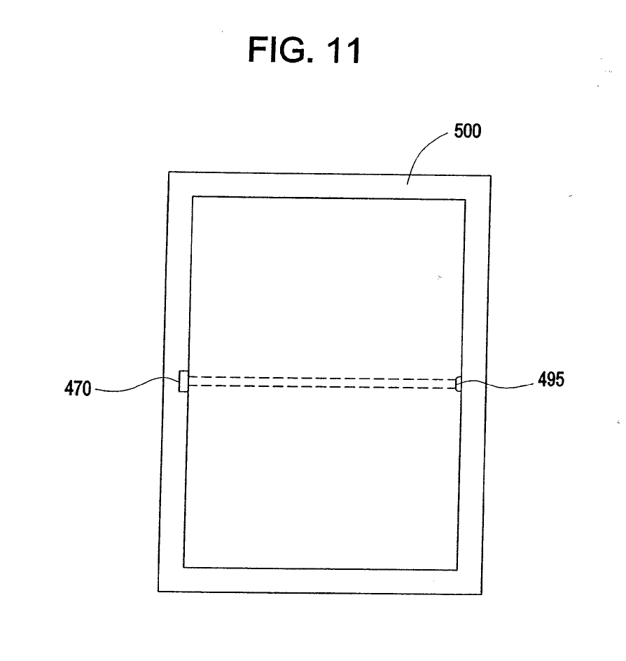

In yet another embodiment, a security system can include a security transceiver/mirror pair, although multiple mirrors can be used. FIG. 10 shows a simplified schematic diagram of illustrative transceiver 470, which includes UV LED 475, UV photodetector 480, energy storage device 485, and microprocessor 490, although microprocessor 490 can be remote from transceiver 470, if desired. As shown in FIG. 11, transceiver 470 can be used in combination with one or more mirrors 495 to secure window 500. During operation, transceiver 470 emits a UV light beam and monitors its reflection from one or more mirrors 495. As shown in FIGS. 10 and 11, both LED 475 and photodetector 480 can be located on the same face of transceiver 470.

Alternatively, multiple pairs can be used to form multiple independent circuits in different portions of a room or different rooms of a building. In this case, the microprocessor could analyze a sequence of circuit interruptions to determine whether the sequence matches a stored sequence that is characteristic of an intruder, a fire, or any other programmed identification.

In other words, the microprocessor can be programmed to determine whether the electrical signal levels generated by the photodetectors change in a way that is consistent with any stored characteristic pattern, such as one that is associated with the presence of a fire. The microprocessor can be further programmed to notify a particular agency, such as the police or the fire department, based on the identify of the source of the interruption. Thus, the microprocessor can further include one or more memory units with appropriate lookup tables and algorithms that can be used to identify the source of the interruption and formulate a notification upon identifying the source.

There are many ways that the microprocessor can be programmed to identify an interruption source. For example, the microprocessor can analyze one or more electrical signals by comparing the electrical signals magnitudes (e.g., levels) to some predetermined level. Thus, an alarm can be triggered, or an identification can be made, if a monitored electrical signal has a magnitude greater than a predetermined threshold level less than a threshold level, or sufficiently different from a particular threshold level

In another embodiment, the microprocessor can analyze one or more electrical signals by determining whether their levels change in a predetermined way. This could include, for example, levels changing by a predetermined amount, levels changing in a predetermined direction, and/or changing by both an amount and in a direction.

Line-of-sight detection methods and apparatus consistent with this invention can also be used to detect the presence of humans for contact-free (e.g., “hands-free”) automated operation of many devices, such as bathroom and kitchen appliances, where contact would otherwise increase the risk of spreading germs.

Line-of-sight detection methods and apparatus consistent with this invention can also be used to monitor and control manufacturing processes more pervasively and with improved accuracy. Due to their low cost and small size, emitter/detector pairs can be used throughout a production process. In addition, due to the low-power requirements, these devices can be wireless, allowing for even more design flexibility in manufacturing. One example of an industrial application is a product counter that monitors and counts the number of products being carried by a manufacturing conveyer belt by determining the number of line-of-sight interruptions.

Line-of-sight detection can also be used to detect the presence of vehicles and measure vehicular speed. Again, the presence of a vehicle can be detected when a line-of-sight interruption is detected. UV detection schemes can also be used, for example, to determine the presence of vehicles in parking lot spaces. This information can be provided to a centralized database programmed to direct automobiles to the nearest vacant parking space. The automobile can further be provided with a UV LED tag (see below), that ensures that the tagged automobile is authorized to park in a particular space.

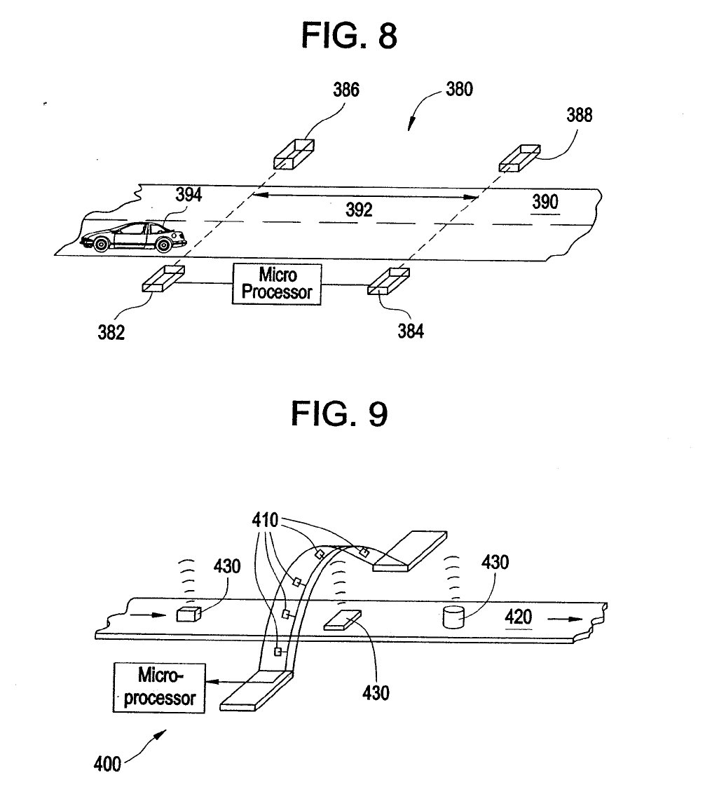

The speed of a vehicle can be measured using at least one emitter-receiver pair. FIG. 8 shows an illustrative system for making such a measurement. System 380 can include two UV photodetectors 382 and 384 and two UV LEDs 386 and 388, forming two UV photodetector/LED pairs, each of which has a line-of-sight across roadway 390. When the pairs are positioned at known distance 392, the presence of vehicle 394 passing through these lines-of-sight will sequentially be detected by each pair. If the time period between these detection events is measured, the speed of the vehicle can be calculated and, if desired, reported. In an alternative embodiment, the single LED/photodetector pair can be used with mirrors so that a folded line-of-sight stretches across a single roadway at least twice. It will be appreciated that when the vehicle detection and speed monitoring systems consistent with this invention use UV light that falls within the solar blind region, those systems can be used day and night without sophisticated noise reduction techniques.

### Physical Tracking Applications

An object can be tracked with UV photodetectors when a low-power UV LED is attached to the object. For example, receivers can be located at fixed positions or placed on mobile, handheld units. The LED can be powered by a photovoltaic cell, a charged capacitor, or a battery, depending on the power requirements of the particular application. If the LED were modulated by a programmed modulating circuit, the UV light can be encoded with a unique identification code. A microprocessor can control the LED creating a carrier signal having a first frequency (e.g., about 1 kHz) and modulating that carrier signal for encoding information at a second frequency (e.g., about 100 Hz).

There are many additional identification applications consistent with this invention. Applications range from supply-chain management, shopping cart checkout procedures (e.g., groceries, etc.), and luggage tracking to supply-chain management schemes. Thus, UV LEDs represent a cost-effective alternative to both optical barcode scanning technologies and other emerging tracking technologies, such as RF identification (“RFID”) methods. Accordingly, UV systems consistent with this invention can reduce supply-chain management expenses, trim inventories, cut losses due to theft, and eliminate misdirected shipments.

Methods and apparatus to facilitate shopping cart checkout can take many forms. In a grocery store environment, for example, a low-cost UV LED with a micro-processor (which may be integrated with the LED) can be attached to each grocery item. The microprocessor can be programmed to cause the LED to periodically or continually emit encoded UV light that is detectable by a stationary or mobile receiver unit. The receiver unit includes a UV photodetector and a microprocessor programmed to at least identify the grocery item to which the LED is attached. The microprocessor can receive the identification information, determine its price, apply any discounts, and add these price to determine a total bill. Alternatively, the identification information can be supplied to another microprocessor that performs these functions.

FIG. 9 shows one type of receiver unit 400 consistent with this invention that includes one or more UV photodetectors 410 positioned above or around (e.g., in the shape of an arc) conveyor belt 420. In this way, conveyor belt 420 conveys items 430 below or inside the arc of photodetectors. Then, as discussed above, photodetectors 410 receive the encoded UV light from each of items 430 as they pass the photo-detectors so that they can be identified and registered. This type of receiver unit can be especially useful for automated checkout lines that do not require the use of a cashier. The UV LED tags can also be used to prevent shoplifting because the light emitted by the LED tag can be detected by another photodetector at a store's exit (not shown).

To prevent false alarms, each LED tag can be deactivated at checkout when it receives a deactivation code (if some form of a receiver is onboard). Alternatively, an LED signal can be uniquely coded to each individual item (as opposed to each product type) and carried to or through checkout in a registered shopping cart. Once registered, the shopping cart can be linked to a credit card or any other type of payment means. When the cart is registered, the checkout procedure can require both a product and cart registration number. In this case, a security detector at the exit of the store can detect the presence of an item, determine whether payment was made, and generate an alarm signal if payment was not made.

In addition to assigning a registration number to a cart, and thereby to an authorized shopper, “smart” carts can be used to automatically provide price information to a shopper when a product is placed in or near the cart. Carts can also electronically store the contents of the cart while a shopper shops and provide advertisement, promotional, or directional information to the shopper based on those contents. For example, different products can be linked, such as a hammer and a box of nails. In this way, when a customer purchases a hammer, the cart can inform the shopper of promotional offers for nails, and/or where to find nails in the store.

In yet another embodiment, smart carts can perform all checkout procedures, thereby entirely eliminating the need for a checkout line at the exit of the store. For example, the cart can keep a running tally of the contents of the cart. In this way, the customer can be automatically charged for the contents in a single transaction before leaving the store.

When a low-power UV LED tag is used to identify a grocery item, for example, an onboard power source can also be provided. The amount of stored energy can be suitably matched to the shelf-life of the item. For example, the amount of stored energy for items that have a short shelf-life, such as refrigerated dairy products, can be much less than the amount required for canned items.

UV LED-based tags can also be used to store other useful information, including the product's shelf-life. Such information could be used by receiver units located on shelves to detect when a particular product's shelf-life has expired. The receiver units could also be used to automate the process of taking an inventory of the products on a shelf, or, more generally, throughout a store.

This UV technology can also be used broadly for many other commerce applications. For example, UV LED-based systems consistent with this invention can replace conventional RF identification technology used in highway toll-collection environments. Furthermore, these systems can replace RF-based identification applications, such as the Speedpass technology already used by the Exxon Mobil Corporation and the McDonald's Corporation, and which is currently being incorporated into wrist watches to be made by the Timex Corporation.

As mentioned above, UV LED tags can also be used to identify and track luggage. For example, an LED tag can be attached to each piece of checked luggage. The LED tag can be programmed to emit light that is encoded with information that reflects the owner of the luggage, its destination, etc. UV receivers can be located along luggage conveyor belts, in airplane cargo holds, and in ground transportation vehicles. The receivers can check that the bags are not being misdirected and conveyor apparatus can even be programmed to sort the luggage based on the destination information.

Low-power UV system consistent with this invention provide a number of benefits when compared with existing RFID and barcode scanner technologies. First, UV light can reach greater distances with reduced power requirements. Also, the UV systems can also be made faster and more accurate than inductive loop and RF-based technologies, which allows more accurate toll collection at relatively higher speeds.

### Solar-Blind and Other Communications

As mentioned above, communication in the “solar-blind” portion of the UV electromagnetic spectrum is not subject to noise from solar background radiation because the earth's ozone layer absorbs most such radiation. Due to the relatively low background noise level in the solar-blind region, UV communication links can be formed using relatively low-power levels and over relatively long distances.

Solar-blind communication systems consistent with this invention can be built by combining two existing but separate technologies. A UV beam of light is emitted by a mercury-vapor lamp or by one or more LEDs that emit UV light in the solar blind region of the electromagnetic spectrum. The emitted light is directed and optionally focused with hundreds of thousands, or even millions, of mirrors, such as those formed on micro-electro-mechanical systems (“MEMS”). Texas Instruments Incorporated, of Dallas, Tex., currently manufactures MEMS devices sold under the trademarks digital light processors (DLP®) and digital micromirror devices (DMD®). To maximize the amount of light that is incident on the MEMs device, lenses, mirrors, and/or waveguides can be used to direct the UV light from the source to the MEMs device. Also, to minimize loss upon reflection of the UV light by the mirrors, the MEMS device can be coated with a UV reflective coating. Thus, MEMs devices, such as DLP® chips, can be used to control the viewing angle, direction, and shape of the UV emission.

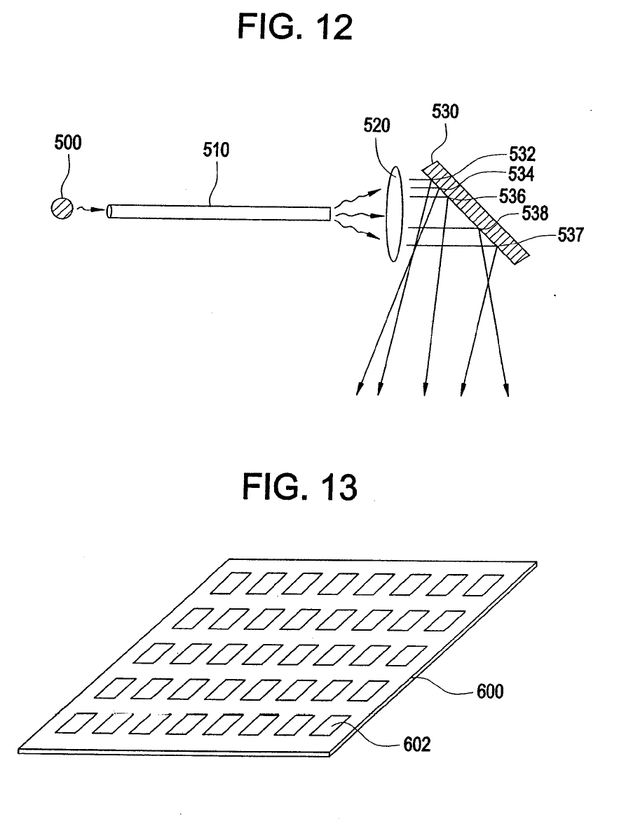

High-bandwidth UV communication systems can also be formed using DMD®-type devices. A high-bandwidth transmitter can include, for example, a UV source, such as a mercury-vapor lamp, and a DMD® that can currently be modulated at high frequencies. By directing a light beam toward the DMD®, the beam can be directed toward and away from a receiver at the same frequencies, thereby forming a communication link between the transmitter and receiver. FIG. 12, for example, shows UV source 500 emitting UV light into waveguide 510 (or alternatively through a vacuum or a gas having a low thermal conductivity). UV light emerges from waveguide 510 and is directed to optional lens 520. Lens 520 can be used to collimate the light toward DMD® 530, which may be gas or liquid cooled. DMD® 530 includes a plurality of separately controllable mirrors 532, 534, 536, 538, and 539 to direct any portion of the fight beam in the same or different directions, as shown. In this way, high-power UV light beams (those having energy densities greater than about 1 milliWatt/cm²) can be shaped using DMD® devices to form one more communication links at extraordinarily long distances.

In another embodiment of this invention, MEMS can be designed such that each separately controllable portion is a photodetector. FIG. 13, for example, shows micro-electro-mechanical photodetector 600 with multiple photodetector portions 602. Because each of portions 602 is independently controllable, a microprocessor can be used to control the orientation of those portions to optimize reception. Varying the orientation of any photodetecting portion would generate a varying electrical signal that could be used in a feedback loop to locate, track, or maintain communication with, a remote light emitting source. When the micro-electro-mechanical photodetector is formed from a material having a relatively high refractive index, such as SiC or AlGaN, the electrical signals generated by the device would be very sensitive to the orientation of each portion. This sensitivity would be useful when trying to, for example, triangulate the position of the light source.

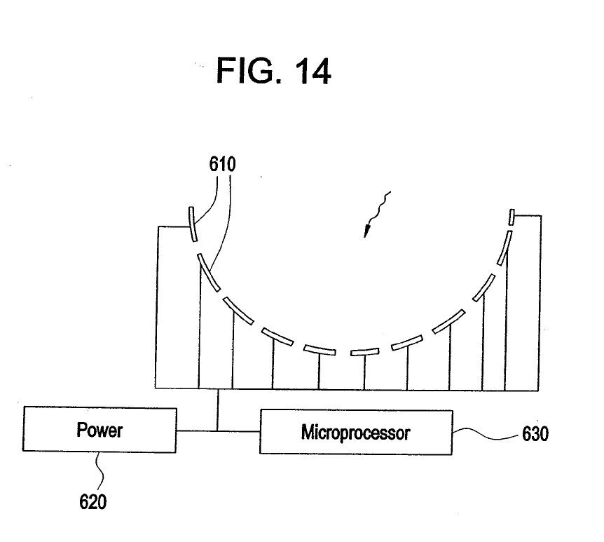

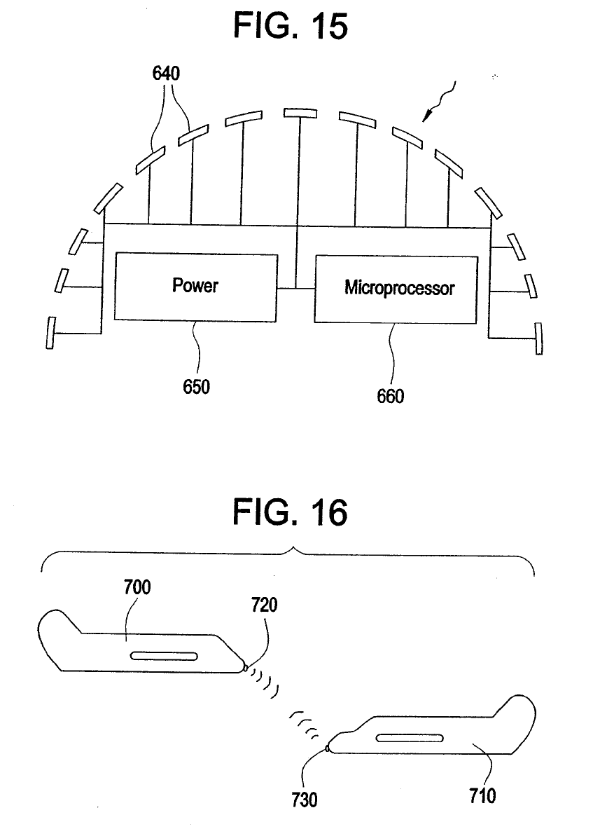

Sensitivity can be increased if two or more micro-electro-mechanical photodetectors are used sequentially or simultaneously. The photodetectors can be placed such that they face the same or different directions. For example, FIG. 14 shows a concave array of micro-electro-mechanical photodetectors 610, each of which is connected to power source 620 and microprocessor 630 for controlling the position of each photodetector portion and processing the electrical signals generated by the many photodetector portions. FIG. 15 shows a convex array of micro-electro-mechanical photodetectors 640, each of which is connected to power source 650 and microprocessor 660 in the same fashion. The array can also be planar, if desired. Due to the extraordinary speeds at which the positions of the photodetector portions can be changed, rapid and highly accurate optimization algorithms can be employed that include hundreds, thousands, or even millions of feedback loops.

It will be appreciated that when an array of two more micro-electro-mechanical photodetectors are used, each one can be fabricated from different materials allowing a single array to operate at multiple UV communication frequencies simultaneously.

Systems consistent with this invention can be used to establish and maintain reliable covert communication links over short, medium, and even extremely long distances (tens or even hundreds of kilometers). Solar-blind communication consistent with this invention makes covert communications possible between aircraft in flight, between devices located on the ground or the sea, and between air, land, and sea-based devices.

UV communication techniques consistent with this invention can also be implemented in aircraft collision avoidance systems. For example, FIG. 16 shows two aircraft 700 and 710 that can be equipped with transceivers 720 and 730, respectively. Each transceiver can include at least one light source that emits a first UV light wave having a wavelength shorter than about 310 nm (or preferably shorter than about 290 nm), a first microprocessor for modulating the first light wave and encoding the first light wave with first location information, a UV photodetector that detects a second UV light wave that was previously encoded with second location information on another aircraft and generates an electrical signal in response to detecting the second UV light wave, and a second microprocessor connected to the photodetector programmed to decode the second location information, compare the first location information with the second location information, and generate a revised flying schedule. The first and second light waves can have the same or different UV wavelengths.

The avoidance system can further include an array of separately controllable mirrors to controllably gather light and direct it toward a photodetector or direct it away from a local light source. The first microprocessor can be electrically coupled to the array such that the array modulates the position of the mirrors thereby encoding information into the first light wave. In one embodiment, the first microprocessor can modulate the position of the mirrors at a rate greater than about 100 Hz, 1 kHz, or even 1 MHz to cause the light intensity at the receiver to modulate accordingly.

1. A wireless remote control unit for use with a low noise UV photodetector comprising:
a UV LED that emits light having a dominant wavelength below about 400 nm;
a microprocessor connected to the LED for controlling the emitted light; and
an energy storage device for storing electrical energy and for powering the LED and the microprocessor.
